(19) United States
(12) Patent Application Publication
(10) Pub. No.: US 2010/0304126 A1
(43) Pub. Date: Dec. 2, 2010

(54) METHOD AND SYSTEM FOR COATING WOOD SUBSTRATES USING ORGANIC COAGULANTS

(75) Inventors: Shaobing Wu, Jamestown, NC (US); Rick Walser, Thomasville, NC (US); Dave Nowak, High Point, NC (US)

Correspondence Address: IPLM GROUP, P.A., POST OFFICE BOX 18455, MINNEAPOLIS, MN, 55418, US

(73) Assignee: Valspar Sourcing, Inc.

(21) Appl. No.: 12/810,436

(22) PCT Filed: Dec. 29, 2008
(86) PCT No.: PCT/US08/88421

§ 371 Date: Aug. 17, 2010

Related U.S. Application Data
(63) Continuation-in-part of application No. 11/770,334, filed on Jun. 28, 2007.
(60) Provisional application No. 61/016,952, filed on Dec. 27, 2007.
(60) Provisional application No. 60/817,577, filed on Jun. 28, 2006.
(60) Provisional application No. 60/917,260, filed on May 10, 2007.

(51) Int. Cl. B32B 5/16; B05D 1/36; C08L 33/00

(52) U.S. Cl. 428/326; 427/408; 524/556

(57) ABSTRACT

Engineered wood product edges are protected by applying a two part edge sealing composition to at least one edge surface. The two part edge sealing composition can improve holdout, hide, and water resistance. An edge sealing system and substrates coated with the sealing system are provided.

### CROSS REFERENCE TO RELATED APPLICATION

This application claims priority from U.S. Provisional Application Ser. No. 61/016,952, filed Dec. 27, 2007, the disclosure of which is incorporated herein by reference.

### TECHNICAL FIELD

This invention is related to a process for coating engineered wood products such as oriented strand board (OSB) panels with improved water resistance, hiding, holdout and product appearance.

### BACKGROUND

Engineered wood products such as oriented strand board, fiberboard, and laminated veneer lumber (LVL), are widely used in residential and commercial construction, and are gaining popularity in markets such as materials handling and the manufacturing of upholstered furniture. These products are available in a variety of forms such as oriented strand board panels, medium density fiberboard (MDF), laminated veneer lumber products, and the like.

Engineered wood products are typically manufactured from small pieces of wood and heat-cured adhesives. Oriented strand board panels are manufactured from heat-cured adhesives and rectangular-shaped wood strands that are arranged in cross-oriented layers. These are commonly referred to as engineered structural panels and have uses that include roof sheathing, wall sheathing, and flooring systems for residential home construction. The manufacturing process makes it possible for panel makers to add innovative features such as a slip-resistant texture to panels designed for roof sheathing, or to supply oversized and metric panels.

Exposure to water can cause engineered wood products such as OSB panels, to undergo irreversible thickness swelling. The worst swelling behavior typically observed is on the edges of the panel. Engineered wood panels tend to swell to a greater extent on the exposed edges in the center. For example, OSB sheets manufactured at a thickness of 720 mils (0.720 inch, 1.829 cm), can actually swell to edge thickness values in excess of 1000 mils (1 inch, 2.54 cm). After drying, these sheets do not recover to their original thickness and instead dry to a swollen edge thickness of about 900 mils.

There are available solutions to the problem of edge swell. Most manufacturers of engineered wood products such as OSB sheets attempt to improve the dimensional stability of the sheet by applying a sealing composition such as a paint formulation to all four edges of the OSB sheet. Typically, the sealer dries into a hydrophobic film, which binds to the OSB sheet and inhibits the absorption of water into the edge of the sheet. Thus, the edge sealant can help to reduce the degree of edge swell experienced by the sheet when it is exposed to water.

Edge sealants are generally applied to engineered wood products such as OSB sheets at the point of manufacture. It is common for a liquid sealant formulation to be applied to the sheets shortly after manufacture. Typically, the formulation dries rapidly after application to the sheets without the use of heating or ventilation equipment. The application of sealers is considered to be an industry standard which provides esthetic value for general marketing purposes and performance advantages to help protect the water-sensitive panels from moisture and rain during the construction phase of a home.

Most sealant formulations are colored and are applied at a level that imparts a solid, uniform, attractive appearance to the engineered wood product unit. After a sealer is applied to the edges of an engineered wood product and dried it should reduce the thickness swelling that typically occurs if the product is exposed to water. Thus, the sealer should dry to form a film that bonds to the wood product and is relatively elastic so that it can expand and stretch as the wood product swells.

There is a need for improving the methods for protecting engineered wood products, particularly the surfaces and edges of substrates which can be exposed to the elements, e.g., water during transportation to customers.

### SUMMARY

The present invention provides a method for coating an engineered wood substrate. The method includes the step of applying a two part coating system having a first part comprising a polymeric coagulating agent and a second part comprising an aqueous coating composition to at least one surface of the substrate (article). In one embodiment, the first part and second part can be applied in succession to the substrate.

The method provides improved swell resistance and improvement in the durability and dimensional stability of the edges of engineered wood products when exposed to water. The invention can also provide superior holdout and provide a more uniform appearance over inconsistent and porous engineered wood product surfaces (e.g., major surfaces). The method can provide a film that is tack-free and non-adhesive.

In another embodiment, the first part and the second part of the coating system are mixed in-flight, e.g., prior to or immediately upon contacting the substrate. The mixing of the two part system, upon or before contact with the substrate, allows for a reduction of the amount of coating composition typically required. The method can provide a film that is tack-free and non-adhesive.

In another embodiment, the invention provides a coating system for an engineered wood substrate where the coating system includes a two part coating composition for coating the surfaces of engineered wood products. The coating system includes a first part having a polymeric coagulating agent and a second part having an aqueous coating composition. The coating system can be applied as described above and can provide a film that is tack-free and non-adhesive.

In another embodiment, the two part coating system can increase the efficiency and enhance the performance of the coating composition. The two part coating system can provide a film that is tack-free and non-adhesive.

In another embodiment, the invention provides articles, wherein the article is prepared from an engineered wood product and has the two-part coating system applied to at least one surface of the substrate. The two-part coating system includes a first part comprising a polymeric coagulating agent and a second part comprising an aqueous coating composition. The coating system includes one or more coating compositions applied to at least one surface of the article.

The above summary of the present invention is not intended to describe each disclosed embodiment or every implementation of the present invention. Other features, objects, and advantages of the invention will be apparent from the description and drawings, and from the claims. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawing and the description below. Other features, objects, and advantages of the invention will be apparent from the description and drawings, and from the claims.

### DETAILED DESCRIPTION

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “a,” “an,” “the,” “at least one,” and “one or more” are used interchangeably. Thus, for example, a coating composition that comprises “an” amine can be interpreted to mean that the coating composition includes “one or more” amines.

The terms “latex polymer resin”, “latex resin” “latex emulsion” or “latex”, refer to a dispersion of polymer particles in water and are used interchangeably. Latex polymer resins typically include one or more dispersing agents (for example, a surfactant) for creating a dispersion or emulsion of polymer particles in water.

The term “mixed in-flight”, refers to the contacting of the first part of the coating system with the second part of the coating system prior to or immediately upon contacting the substrate.

The term “comprises” and variations thereof does not have a limiting meaning where such term appears in the description or claims. Thus, for example, a composition comprising a wax compound means that the composition includes one or more wax compounds.

The recitation of numerical ranges by endpoints includes all numbers subsumed within that range (e.g., 1 to 5 includes 1, 1.5, 2, 2.75, 3, 3.80, 4, 5, etc.).

In another embodiment, the first part and the second part of the coating system are mixed in-flight, prior to or immediately upon contacting the substrate. The mixing of the two part system, upon or before contact with the substrate, allows for a reduction of the amount of coating composition typically required. The method can provide a film that is tack-free and non-adhesive.

The present invention provides a method for protecting the surfaces of engineered wood products wherein the method includes the step of applying a two part coating composition to at least one surface of a substrate where the first part includes a polymeric coagulating agent and the second part includes an aqueous edge sealing composition. In another embodiment the first part can include a filler.

The present invention also provides a coating system for coating at least one surface of a substrate such as an engineered wood product. The coating system preferably includes a first part having a polymeric coagulating agent and a second part having an aqueous edge sealing composition. The coating system includes one or more layers of the two part coating system applied to at least one surface of the substrate. When more than one layer is applied, each layer of the coating system can be the same or different. The disclosed coating system is particularly suitable for coating the major surfaces or the edges of engineered wood substrates such as OSB.

While not intending to be bound by theory, the first part of the two part sealing system may enhance the performance of the edge sealing composition by retarding the absorption of the edge sealing composition into the wood fibers or enhancing the coagulation of the edge sealing composition on the surface of the substrate, to help minimize penetration of the coating composition into the substrate. By minimizing the penetration of the coating composition into the porous wood fibers, a more continuous dry film is achieved which provides a more uniform appearance, and enhanced hide. For example, when the two-part sealing system is used on the edges of an engineered wood substrate, e.g., OSB sheets, superior edge swell resistance is observed.

In one embodiment, the first part of the composition includes a coagulating or flocculating agent. The terms “coagulating agent,” “coagulant,” or “coagulation agent,” “flocculating agent,” “flocculant,” or “flocculation agent” are used interchangeably, and include substances that can serve to unite molecules or dispersed particles to coagulate or form flocs. Non-limiting examples of coagulating agents include inorganic compounds such as sulphates, chlorides, phosphates, carbonates and the like; esters such as phosphate esters, and the like; acids such as, sulphuric, hydrochloric, phosphoric, acetic, citric, p-toluene sulfonic acid (PTSA), and the like. Exemplary inorganic coagulants include magnesium sulphate, aluminum sulphate, ammonium aluminum sulphate, iron sulphate, calcium sulphate, ferrous sulphate, ferric sulphate, zinc sulphate, aluminum chloride, Al(OH)Cl₂, magnesium chloride, iron chloride, calcium chloride, stannous chloride, stannic chloride, zinc chloride, ferrous chloride, ferric chloride, zinc ammonium carbonate, aluminum carbonate, aluminum phosphate, zinc phosphate, ferrous phosphate, polyaluminum chloride, polyvinylsulfonic acid, or mixtures thereof. Coagulants also include organic polymeric compounds such as polyacrylamides, polymethacrylamides, polyacrylic acids, polymethacrylic acids, n-vinyl acrylamides, polyquaternary amines, alkylamine-epichlorohydrin copolymers, hydrolyzed polyarylamides, polyvinyl alcohols, starches, and the like. Exemplary organic polymer coagulants include polyacrylamide, polymethacrylamide, poly-N,N-dimethylacrylamide, N-methylol polyacrylamide, poly-2-hydroxyisopropylacrylamide, polymethylenebisacrylamide, polydimethyl-aminopropyl methacrylamide (DMAPMA), polydiacetone-acrylamide, poly-N-vinyl acrylamide, polyacrylic acid acrylamide, poly-2-hydroxypropyl acrylate, poly-2-hydroxypropyl methacrylate, polyethylene glycol dimethacrylate, polyacrylic acid, sodium polyacrylate, polymethacrylic acid, dimethylamine-epichlorohydrin copolymer, polyethylenimine, polyvinyl pyridine, poly-N-vinylpyrrolidine, polyvinylamine hydrochloride, poly-2-hydroxy-3-methacryloxypropyl-trimethyl ammonium chloride, polymethacrylamidopropyl trimethylammonium chloride (MAPTAC), polymethacrylamido-hydroxypropyl trimethylammonium chloride (G-MAC), cationic starch, polyvinyl alcohol, and the like

Exemplary commercial coagulating products of those agents are Marfloc™ 5242, Marfloc 2150, Milfloc V-27, Alum, Tramfloc™ 860-899, Tramfloc 100, Tramfloc 29, Tramfloc 540-559, Tramfloc 540-560, Crodazoline “O”, Zelec™ “UN”, Arquad T-50 and the like. Preferred products include Tramfloc 867A, and Milfloc V-27. A preferred group of coagulating agents includes organic polymeric compounds, dimethylamine-epichlorohydrin copolymer, polydimethyldiallylammonium chloride, polymethacrylamido-hydroxypropyltrimethyl-ammonium chloride, and polyvinyl alcohol. Also a coagulant mixture including at least one inorganic compound with at least one organic polymeric compound is preferred. Exemplary inorganic coagulants for mixing with organic polymeric coagulants include magnesium sulphate, aluminum sulphate, ammonium aluminum sulphate, aluminum chloride, magnesium chloride, calcium sulphate, calcium chloride, or mixture thereof. The preferred inorganic coagulant is aluminum sulphate (alum). A preferred combination of coagulants include polydimethyldiallylammonium chloride/aluminum sulphate (alum), polyacrylamides/aluminum sulphate, polyvinyl alcohol/aluminum sulphate.

The amount of coagulating agent in the first part of the two part edge sealing composition may be from about 1 to about 60% by weight, preferably from about 2 to about 35% by weight, and more preferably from about 2 to about 10% by weight, based on the total weight of the components in the two part sealing composition.

In another embodiment, the second part of the coating composition further includes a filler. The filler may extend, lower the cost of, or provide desirable characteristics to an aqueous coating composition before and after curing. Non-limiting examples of fillers include, for example, clay, glass beads, calcium carbonate, talc, silicas, organic fillers, and the like.

Aqueous coating compositions may include, for example, water, an aqueous dispersion of one or more waxes, and an aqueous polymer resin. The polymer resins can include latex resins. Non-limiting examples of aqueous coating compositions are disclosed in U.S. Pat. Nos. 6,608,131 and 4,897,291. Non-limiting examples of commercial aqueous coating compositions for coating edges of substrates such as OSB, include ULTRA SEAL™ or EDGE SEAL™ from The Valspar Corporation; CBS™.

The aqueous coating compositions may include a wax emulsion and a polymer resin. Exemplary wax emulsions include from about 20% by weight wax solids to about 90% by weight wax solids based on the total weight of the second part of the coating composition. Preferably, the compositions have from about 30% by weight wax solids to about 80% by weight wax solids. More preferably, the coating compositions have about 40% by weight wax solids to about 70% by weight wax solids.

The polymer resin in the aqueous coating composition is substantially free of reactive olefinic groups. A polymer resin is substantially free of reactive olefinic groups when at least 95% the olefinic monomers that form the polymer resin are reacted (no more than 5% unreacted monomer remains), preferably at least 97% of the olefinic monomers are reacted (no more than 3% unreacted monomer remains), and more preferably at least 99% of the olefinic monomers are reacted (no more than unreacted monomer remains).

Exemplary latex polymer resins include polyurethanes, polyamides, chlorinated polyolefins, acrylics, vinyls, oil-modified polymers, polyesters, and mixtures or copolymers thereof. Non-limiting examples of latex resins include vinyl resins such as acrylic resins, styrene-butadiene rubber resins, vinyl halide resins, acetate resins, and the like or mixtures thereof. Latex polymers can be prepared through chain-growth polymerization, using one or more olefinic monomers.

Substrates or articles that can be coated using the disclosed method include engineered wood substrates. The term “engineered wood products” generally refer to products or substrates that are prepared from any wood pieces such as sheets, chips, flakes, fibers, strands (e.g., rectangular-shaped wood strands), saw dust, and the like. The pieces are typically bonded together, often with an adhesive. Non-limiting examples of engineered wood products include oriented strand board (OSB), fiberboard, laminated veneer lumber products such as plywood, door skins, and the like.

The term “fiberboard” refers to a type of engineered wood product that is made out of wood fibers. Typically, fiberboard is a building material composed of wood chips or plant fibers bonded together and compressed into rigid sheets. Types of fiberboard in order of increasing density include particle board, medium-density fiberboard and hardboard, sometimes referred to as high-density fiberboard. Fiberboard is sometimes used as a synonym for particle board. However, particle board typically refers to low-density fiberboard. Fiberboard, particularly medium-density fiberboard, is heavily used in the furniture industry. For pieces that will be visible, a veneer of wood can be glued onto fiberboard to provide the appearance of conventional wood.

The substrates are coated on one or more surfaces with a two part coating system. The coating system includes a first part having a coagulating agent and a second part having an aqueous coating composition. The coating system may be applied in one or more layers.

The two part coating composition can provide improved hide and holdout. The term “hide” refers to the ability of the coating composition to cover or color a surface uniformly and hide any variations in the color of the coated surface of the substrate. A sealing system having “good” hide will typically require a thinner coating layer to provide an acceptable uniform appearance on the finished substrate. The term “holdout” refers to the ability of the coating to resist excessive penetration into the pores on the surface of the substrate that is coated. A coating system having good holdout will not require large amounts of the coating system to provide an acceptable uniform appearance on the finished surface. The disclosed method can reduce the amount of coating composition typically required to achieve good hide and holdout.

The disclosed coating method and coating systems may have improved, e.g., lower, volatile organic content (VOC). Preferred coating systems have a VOC of less than about 5%, more preferably less than about 2%, and most preferably less than about 0.5%, based on the total weight of the two part coating composition.

The coating system can be applied as a single coating layer or as multiple layers using one or more than one aqueous coating compositions (e.g., a first layer having one coating composition and a second layer having a different coating composition). The specific application and order of application of the selected aqueous coating compositions can be readily determined by a person skilled in the art of preparing or applying such compositions. Exemplary descriptions of these aqueous based coating systems are described above. Accordingly, the substrates can be prepared by applying the two part coating composition in a single application (layer) or the two part coating compositions can be applied in multiple layers. The edge sealing composition(s) are preferably applied at about 5 to 65% solids by weight, more preferably at about 20 to 55% solids, and most preferably at about 35 to 50% solids. Preferred edge sealing composition(s) contain less than 5% volatile organic compounds, more preferably, a VOC of less than about 2%, and most preferably a VOC is less than 0.5%, based on the total weight of the coating system.

The two part coating system is preferably applied by any number of application techniques known in the art, including but not limited to brushing, brush coater, direct roll coater, reverse roll coater, flood coater, vacuum coater, curtain coater or various spraying techniques. Exemplary spraying techniques include, e.g., two gun, dual nozzles, single gun with multiple spray nozzles and the like. The two parts can be applied using a single applicator that can apply the two parts independently (e.g., the two parts do not mix within the applicator) or the two parts can be applied simultaneously from separate spraying units, e.g., separate spray guns. Non-limiting examples of single applicators include a Binks Mach 1 PCX Plural Component paint sprayer, spray guns disclosed in U.S. Pat. Nos. 6,264,113, 5,639,027, 5,400,971 or the like. The various techniques each offer a unique set of advantages and disadvantages depending upon the substrate profile, morphology and tolerable application efficiencies.

The film thickness of the layer(s) can be controlled by application rate. The dry film thickness (DFT) of the coating system layer(s) on engineered wood substrates may be in the range of, for example, about 1 to about 10 mils (0.0025 to 0.025 cm), more preferably about 2 to about 8 mil (0.0051 to 0.0203 cm), and most preferably about 2 to about 6 mil (0.0051 to 0.015 cm).

Exemplary wet film thicknesses of the two part edge sealing composition on engineered wood substrates are in the range of, for example, about 2 to about 20 mils, more preferably about 4 to about 15 mils, and most preferably about 4 to about 8 mils.

It is preferred that the substrates are coated on at least one surface with the disclosed coating system. More preferably, the substrates of the invention are coated on two surfaces or four surfaces. In addition, a topcoat may be applied directly to the disclosed coating system.

Exemplary optional pigments for use in the disclosed coating compositions include, for example, titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, or organic yellows (such as Hansa yellow). The composition can also include a gloss control additive or a commercially available optical brightener such as UVITEX OB from Ciba-Geigy.

The coating system can also include a filler. Exemplary optional fillers and inert ingredients for use in the disclosed coating compositions include, for example, clay, glass beads, calcium carbonate, talc, silicas, organic fillers, and the like.

The disclosed coating system may also include other ingredients that modify properties of the composition as they are stored, handled, or applied, and at other or subsequent stages. Additional optional components or additives for use in the coating compositions include surface active agents (surfactants), pigments, colorants, dyes, fillers, sedimentation inhibitors, ultraviolet-light absorbers, optical brighteners, thickeners, heat stabilizers, leveling agents, anti-cratering agents, curing indicators, plasticizers, biocides, mildewcides, surfactants, dispersants, defoamers, and the like. Flatting agents, mar and abrasion additives and other similar performance enhancing additives may be employed as required in amounts effective to upgrade or otherwise alter the performance of the cured coating and the coating composition. Desirable performance characteristics of the coating include chemical resistance, abrasion resistance, hardness, gloss, reflectivity, appearance, or combinations of these characteristics, and other similar characteristics. Non-limiting examples of exemplary additives for use with the disclosed coating compositions are described in Koleske et al., Paint and Coatings Industry, April, 2003, pages 12-86.

The invention will be described by the following non-limiting examples.

### EXAMPLES

### Example 1

### General Edge Swell Test Procedure

Test panels are prepared by cutting an OSB sheet into test panels (usually about 12″ long and 4″ wide) using a sharp saw blade. The test panels are bundled together into a stack and placed in a 150° F. (65.6° C.) oven for two hours prior to application of the coating composition.

The samples are removed from the oven and “stack” sprayed. The coagulant is applied simultaneously with or immediately followed by application of the coating composition. The edges are allowed to dry or harden for at least 24 hours at ambient temperature.

After drying, the test panels are separated and the edges are protected by application of an “Apron” (a 1-inch strip of a hydrophobic coating composition applied with a brush adjacent to the test edge surfaces) around the entire perimeter to prevent water from penetrating the non-test surfaces. The test panels are then equilibrated for three days before beginning the soak tests.

The thickness measurements are obtained using a Mitutoyo digimatic indicator mounted to a gage stand and fitted to a test jig. Thickness measurements are taken at one inch intervals starting one and one half inches from the ends of the test panels. This provides about nine (9) measurements for each panel. The measurements are averaged to provide a thickness value for each sample.

Once the initial measurements are complete, all the samples are placed in a large edge soak tank. A 2-inch thick piece of upholstery foam is placed under the test panels in the soak bath. The tap water in each tank is maintained at a level ⅛″ below the surface of the foam by refilling the bath at least once per day during the evaluation period.

The test panels are removed and measurements are taken after 72-hour intervals for tracking and evaluation purposes. Percent swell for each test set is determined by subtracting the average final thickness from the average initial thickness then dividing by the average initial thickness. Percent efficiency for each test set is determined by subtracting the test set's average swell value from the uncoated OSB swell value then dividing by the uncoated OSB swell value.

### Example 2

### Application for Coating High Density Fiber Boards (Door Skins)

The coating system consisted of two components: Component A was a coagulant solution, prepared at 10 wt % in water. The coagulants tested were summarized in Table 1. Component B was a water-based (latex) primer prepared as recited in Table 2.

The door skin substrates were cut 8 inches wide and 30 inches long and heated in an infrared (IR) oven to a board surface temperature at 150° F. (65.6° C.). Components A and B were sequentially applied to the substrate samples with by an automated spray system having two spray gun nozzles. The coating weight of the component A was controlled at 2.0, 3.5 and 5.0 g/ft² and the coating weight of the component B was controlled at 5.2 g/ft². After the application of component B (primer), the substrates were dried in a high velocity oven at 350° F. (177° C.) for 15 seconds. The holdout and adhesion of the coated samples were compared and evaluated after cooling and stabilization to room temperature (˜70° F., 21.1° C.) over night.

TABLE 1
Effects of Coagulants on Holdout and Adhesion

| | | | Coating | | |
|---|---|---|---|---|---|
| | Component A: coagulant | Trade | Weight, | Hold | Ad- |
| Sample | solution | Name | g/ft² | out* | hesion* |
| 1 | Control (no pretreatment) | NA | NA | 7 | 10 |
| 2 | Aluminum sulphate | Alum | 5.0 | 10 | 3 |
| | | | 3.5 | 10 | 4 |
| | | | 2.0 | 9 | 9 |
| 3 | Dimethylamine- | Tramfloc | 5.0 | 10 | 8 |
| | epichlorohydrin co- | 867A | 3.5 | 10 | 10 |
| | polymer | | 2.0 | 10 | 10 |
| 4 | Polydimethyldiallyl- | Tramfloc | 5.0 | 7 | 7 |
| | ammonium chloride | 635 | 3.5 | 7 | 10 |
| | | | 2.0 | 8 | 10 |
| 5 | Polydimethyldially- | Tramfloc | 5.0 | 8 | 10 |
| | ammonium chloride and | 552 | 3.5 | 7 | 10 |
| | aluminum sulphate | | 2.0 | 9 | 10 |
| 6 | Polyvinyl alcohol and | NA | 5.0 | 9 | 6 |
| | aluminum sulphate | | 3.5 | 9 | 9 |
| | | | 2.0 | 9 | 10 |
| 7 | Polydimethyldiallyl- | Milfloc | 5.0 | 10 | 6 |
| | ammonium chloride + | | 3.5 | 8 | 9 |
| | alum | | 2.0 | 9 | 10 |

*Scale: 0-10, 0-the worst, 10- the best

TABLE 2
Water-based (latex) Primer for High Density Fiber Boards

| | Ingredients | weight, % |
|---|---|---|
| 1 | Styrene-acrylic emulsion | 24.5 |
| 2 | Co-solvents | 2.5 |
| 3 | Dispersants | 1.5 |
| 4 | Pigments | 40 |
| 5 | defoamers | 2.1 |
| 6 | surface actives | 2.2 |
| 7 | viscosity controlling agents | 1.5 |
| 8 | Tints | 3.1 |
| 9 | water | 22.6 |
| 10 | Total | 100 |

### Example 2

### Application for Edge Coating of OSB Boards

The coating system consisted of two components: Component A was a coagulant solution in water, prepared at the levels summarized in Table 3. Component B is a water-based primer recited in Table 4.

Test panels (OSB) are cut 12″ long and 4″ wide using a sharp saw blade. The test panels are, bundled together into a stack and placed in a 150° F. (65.6° C.) oven for two hours prior to application of the coating system.

The samples are removed from the oven and “stack” sprayed. The coagulant is applied simultaneously with or immediately followed by application of the coating composition. The edges are allowed to dry or harden for at least 24 hours at ambient temperature.

Each coating material (coagulant and coating composition) is loaded into a specially assembled spray system so that component A and component B were applied simultaneously to the edge of the substrate by in-flight mixing, before contacting the substrates. The coat weight of the component A and component B were controlled at 5 and 18 g/ft², respectively. The coated samples were allowed to dry or harden for at least 24 hours at ambient temperature before water soaking testing.

The test panels are measured for thickness. After measuring, the test panels are placed in the soak tank for 72-hours. After the test period the test panels are re-measured. The results are summarized in Table 3.

TABLE 3
Edge Swell and water absorption as a function of coagulants

| | Component A: | | | Edge | Corrosion |
|---|---|---|---|---|---|
| | coagulant | Coagulant | Coagulant | Swelling, | Effects |
| Sample | solution | Composition | Levels | 72 h | (weight loss, mg) * |
| 1 | Control | NA | NA | 23.1 | none |
| 2 | Alum | Aluminum sulphate | 3.5 | 5.0 | 14 |
| | | | 7.0 | 5.6 | 13 |
| | | | 10 | 6.1 | 14 |
| 3 | Milfloc | Polydimethyldiallyl- | 3.5 | 10.2 | 7 |
| | V-27 | ammonium chloride + | 7.0 | 5.2 | 6 |
| | | alum | 10 | 5.0 | 7 |

* Tin-plated steel (#0.25, 7.00 games) was soaked in the coagulant solution for 24 hours and then measure the weight loss.

TABLE 4
Water-based (latex) Primer for OSB

| | Ingredients | weight, % |
|---|---|---|
| 1 | STYRENE ACRYLIC EMULSION | 20 |
| 2 | Wax emulsion | 40 |
| 3 | dispersants | 1.5 |
| 4 | Pigments | 11 |
| 5 | defoamers | 2.5 |
| 6 | surface actives | 2.5 |
| 7 | viscosity controlling agents | 1.5 |
| 8 | Tints | 5.4 |
| 9 | water | 15.6 |
| 10 | Total | 100 |

All patents, patent applications and literature cited in the specification are hereby incorporated by reference in their entirety. In the case of any inconsistencies, the present disclosure, including any definitions therein will prevail. The invention has been described with reference to various specific and preferred embodiments and techniques. However, it should be understood that many variations and modifications may be made while remaining within the invention.

1. A method for coating an engineered wood substrate comprising the steps of:
providing an engineered wood substrate; and
applying a two part coating system having a first part comprising a polymeric coagulating agent and a second part comprising an aqueous coating composition to at least one surface of the substrate.

2-4. (canceled)

5. The method of claim 1, wherein the coagulating agent comprises a polyacrylamide, polymethacrylamide, polyacrylic acid, polymethacrylic acid, n-vinyl acrylamide, polyquaternary amine, alkylamine-epichlorohydrin copolymer, hydrolyzed polyacrylamide, polyvinyl alcohol, starch or mixture thereof.

6. The method of claim 2, wherein the coagulating agent comprises polyacrylamide, polymethacrylamide, poly-N,N-dimethylacrylamide, N-methylol polyacrylamide, poly-2-hydroxyisopropylacrylamide, polymethylenebisacrylamide, polydimethylaminopropyl methacrylamide (DMAPMA), polydiacetone-acrylamide, poly-N-vinyl acrylamide, polyacrylic acid acrylamide, poly-2-hydroxypropyl acrylate, poly-2-hydroxypropyl methacrylate, polyethyleneglycol dimethacrylate, polyacrylic acid, sodium polyacrylate, polymethacrylic acid, polyethyleneimine, polyvinyl pyridine, poly-N-vinylpyrrolidone, polyvinylamine hydrochloride, poly-2-hydroxy-3-methacryloxypropyl-trimethyl ammonium chloride, polymethacrylamidopropyl trimethylammonium chloride (MAPTAC), dimethylamine-epichlorohydrin copolymer, polydimethyldiallylammonium chloride, polymethacrylamido-hydroxypropyl trimethylammonium chloride (G-MAC), cationic starch, polyvinyl alcohol or mixture thereof.

7. (canceled)

8. The method of claim 1, wherein the coagulating agent further comprises an inorganic compound, comprising one or more of magnesium sulphate, aluminum sulphate, ammonium aluminum sulphate, iron sulphate, calcium sulphate, ferrous sulphate, ferric sulphate, zinc sulphate, aluminum chloride, Al(OH)Cl₂, magnesium chloride, iron chloride, calcium chloride, stannous chloride, stannic chloride, zinc chloride, ferrous chloride, ferric chloride, zinc ammonium carbonate, aluminum carbonate, aluminum phosphate, zinc phosphate, ferrous phosphate, phosphate esters, sulphuric acid, hydrochloric acid, phosphoric acid, acetic acid, citric acid, p-toluene sulfonic acid or mixture thereof.

9-12. (canceled)

13. The method of claim 1, wherein the coagulating agent is about 2 to about 35% by weight, based on the total weight of components in the two part coating system.

14. (canceled)

15. The method of claim 1, wherein the aqueous coating composition comprises a wax emulsion and a polymer resin and wherein the aqueous coating composition comprises about 40% by weight wax solids to about 80% by weight wax solids.

16-18. (canceled)

19. The method of claim 1, wherein the polymer resin comprises a latex resin comprising an acrylic resin, styrene-butadiene rubber resin, acetate resin, or mixture thereof.

20-26. (canceled)

27. The method of claim 1, wherein the engineered wood substrate comprises fiberboard, a laminated veneer lumber product or oriented strand board.

28-29. (canceled)

30. The method of claim 1, wherein the aqueous coating composition provides a film thickness of about 0.0051 to about 0.0203 cm.

31. (canceled)

32. An edge sealing system for an engineered wood substrate comprising; comprising:
a first part comprising a polymeric coagulating agent and a second part comprising an aqueous coating composition.

33-34. (canceled)

35. The edge sealing system of claim 32, wherein the aqueous coating composition comprises a wax emulsion and a polymer resin.

36-37. (canceled)

38. A coated article comprising:
an engineered wood substrate; and
a two part coating system applied to the substrate,
wherein the coating system comprises a first part comprising a polymeric coagulating agent and a second part comprising an aqueous coating composition.

39. The coated article of claim 38, wherein the coagulating agent comprises a polyacrylamide, polymethacrylamide, polyacrylic acid, polymethacrylic acid, n-vinyl acrylamide, polyquaternary amine, alkylamine-epichlorohydrin copolymer, hydrolyzed polyarylamide, polyvinyl alcohol, starch or mixture thereof.

40. The coated article of claim 38, wherein the coating system includes two or more coating compositions that may be applied in two or more layers.

41. The coated article of claim 38, wherein the aqueous coating composition comprises a wax emulsion and a polymer resin.

42. The coated article of claim 41, wherein the polymer resin comprises a latex resin, comprising an acrylic resin, styrene-butadiene rubber resin, acetate resin, or mixture thereof.

43. (canceled)
